(19) United States
(12) Patent Application Publication
(10) Pub. No.: US 2026/0118134 A1
(43) Pub. Date: Apr. 30, 2026

(54) Method for Updating Digital Map Material for a Navigation System

(71) Applicant: Bayerische Motoren Werke Aktiengesellschaft, Muenchen (DE)

(72) Inventors: Mariia ANISIMOVA, Muenchen (DE); Leonhard KUENZLER, Markt Schwaben (DE)

(21) Appl. No.: 19/367,476

(22) Filed: Oct. 23, 2025

(30) Foreign Application Priority Data
Oct. 24, 2024 (DE) 10 2024 131 096.0

(51) Int. Cl. G01C 21/00; G01C 21/36

(52) U.S. Cl. CPC G01C 21/3807; G01C 21/3682; G01C 21/3848

(57) ABSTRACT

A method for updating digital map material for a navigation system includes, during a journey of a vehicle to a facility for stationary traffic represented in the digital map material, capturing vehicle data which can indicate that the facility for stationary traffic is located under a roof or inside a building. It is determined whether the facility for stationary traffic is located under a roof or inside a building based on the captured vehicle data. If it is determined that the facility for stationary traffic is located under a roof or inside a building, the digital map material is updated such that information about whether the facility for stationary traffic is located under a roof or inside a building is stored. The updated digital map material is then provided.

### CROSS REFERENCE TO RELATED APPLICATION

This application claims priority under 35 U.S.C. § 119 from German Patent Application No. DE 10 2024 131 096.0, filed Oct. 24, 2024, the entire disclosure of which is herein expressly incorporated by reference.

### BACKGROUND AND SUMMARY

The present invention relates to a method for updating digital map material for a navigation system, using which the digital map material can be expanded or supplemented with information which specifies whether a facility for stationary traffic contained or represented in the digital map material is located under a roof or in a building.

Digital map material is generally understood as the preparation, processing, or operative application of maps in digital form, i.e. map material existing in digital form. In this case, for example, navigation systems of a motor vehicle access digital map material for route planning from a present location or a selected starting location to a desired destination point.

A facility for stationary traffic contained or represented in the digital map material is furthermore understood as a stationary or static object represented in the digital map material, for example, an infrastructure component or a corresponding point of interest (POI), to which a destination guidance can be started based on the digital map material, for example, a charging station for electric vehicles.

Conventional navigation systems are based on a current location being calculated from signals of a global positioning system (GPS) and a destination guidance taking place based on the determined current location and digital map material.

However, it has proven to be disadvantageous in this case that it is often only possible to a restricted extent to receive GPS signals in enclosed buildings. Moreover, facilities for stationary traffic or the entrances thereto which are represented in the digital map material can often only be recognized with difficulty, in particular if the object is located under a roof or in a building, which additionally obstructs navigation to the object.

A method for operating a navigation system for a vehicle, in particular a motor vehicle, is known from document EP 1 405 039 B1, in which data on geographic positions of the vehicle are determined by a localizing system and can be transmitted to a device for electronic data processing having access to a database and a digital roadmap and the location of the vehicle on the digital roadmap is determined on the basis of these data and visual and/or acoustic destination guidance instructions are output to the driver of the vehicle, wherein additional information relevant for the navigation is loaded in the form of user programs onto the navigation system, which are usable by the driver and/or other people located in the vehicle.

The object of embodiments of the invention is to enable improved navigation to a facility for stationary traffic represented in digital map material.

This object is achieved by the subject matter disclosed herein.

According to one embodiment of the invention, this object is achieved by a method for updating digital map material for a navigation system, wherein during a navigation of a vehicle to a facility for stationary traffic represented in the digital map material by the navigation system, vehicle data which can indicate that the object is located under a roof or inside a building are captured, wherein it is determined based on the captured vehicle data whether the facility for stationary traffic is located under a roof or inside a building, and wherein, if it is determined that the facility for stationary traffic is located under a roof or inside a building, the digital map material is updated in that information about the fact that the facility for stationary traffic is located under a roof or in a building is stored in the digital map material, and the correspondingly updated map material is provided.

Vehicle data are understood in this case as data in conjunction with a control of the vehicle or data captured during operation of the vehicle, which can indicate that the vehicle is currently located under a roof and/or inside a building, for example, current weather data and/or light data and/or data which indicate that the vehicle drives onto another level or into another floor.

The digital map material being updated accordingly furthermore means that additional information is saved or stored which indicates or is representative of the fact that the facility for stationary traffic is located under a roof and/or inside a building.

Based on the updated digital map material, it is then possible to reliably navigate to the facility for stationary traffic, even if it is located under a roof or inside a building and accordingly it is only possible to receive GPS signals to a restricted extent or the facility for stationary traffic or an entrance thereto can only be recognized with difficulty.

Overall, improved navigation to a facility for stationary traffic represented in digital map material is therefore enabled.

In at least one embodiment, the vehicle data are captured after the vehicle has reached a position of the facility for stationary traffic stored in the digital map material.

The position of the facility for stationary traffic is understood in this case as the coordinates of the facility for stationary traffic stored in the digital map material.

In this way, it can be ensured that the vehicle data are only captured when they see is also necessary, by which resources, in particular storage capacities, can be saved, so that the method can also be executed on computing units having comparatively few resources.

The vehicle data can in this case be a current signal reliability of a GPS signal and/or data captured by a light sensor and/or data captured by a rain sensor and/or data captured by an ambient temperature sensor and/or data captured by a sensor which is designed to detect a height change.

A current signal reliability of a GPS signal is understood here as a current perception quality or reception strength of the GPS signal.

A sensor, which is also referred to as a detector, (measured variable or measurement) pickup, or (measurement) feeler, is furthermore a technical component which can detect specific physical or chemical properties and/or the material composition of its surroundings qualitatively or quantitatively as a measured variable.

A light sensor is in this case a sensor designed to measure an ambient brightness.

A rain sensor is furthermore a sensor designed to establish whether and how strongly it is raining.

An ambient temperature sensor is furthermore a sensor which measures the temperature outside the vehicle and in particular of a passenger compartment.

A sensor which is designed to detect a height change is furthermore a sensor which can detect a vertical acceleration or a current altitude.

Overall, the vehicle data can include all data, in particular data about a signal quality and/or whether data and/or light data, based on which it can be determined whether the vehicle is located under a roof and/or in a building.

The fact that the vehicle data can in this case be data about a current signal reliability of a GPS signal and/or data captured by a light sensor and/or data captured by a rain sensor and/or data captured by an ambient temperature sensor and/or data captured by a sensor designed to detect a height change is only one possible embodiment, however. Rather, the vehicle data can also include other data, for example, which indicate that the vehicle is driving onto another level or into another floor.

The vehicle can furthermore be a motor vehicle.

A motor vehicle is understood here as a road vehicle driven by machine.

In particular in motor vehicles, it can prove to be disadvantageous here that receiving GPS signals in enclosed buildings is often only possible to a restricted extent, or facilities for stationary traffic represented in digital map material or the entries thereto can often only be recognized with difficulty, if the facility for stationary traffic is located under a roof or in the building, which additionally obstructs navigation to the facility for stationary traffic.

The facility for stationary traffic can furthermore be a charging station for electric vehicles. The number of charging stations for electric vehicles is thus continuously increasing and charging stations are also arranged more and more under roofs or in buildings, for example, parking garages or underground garages.

At least one embodiment also specifies a method for navigating a vehicle to a facility for stationary traffic by means of digital map material, wherein the method includes updating the digital map material by way of an above-described method for updating digital map material for a navigation system, receiving an input which defines a facility for stationary traffic represented in the updated digital map material as the destination of a route plan by the navigation system, and navigating to the facility for stationary traffic based on the updated digital map material.

A method is therefore specified using which improved navigation to a facility for stationary traffic represented in digital map material is again enabled. Based on the updated digital map material, it is possible to navigate reliably to the facility for stationary traffic in this case, even if it is located under a roof or inside a building and accordingly receiving GPS signals is only possible to a restricted extent or the facility for stationary traffic or an entry thereto can only be recognized with difficulty.

At least one embodiment also specifies a system for updating digital map material for a navigation system, wherein the system includes a capture unit which is designed to capture, during a journey of a vehicle to a facility for stationary traffic represented in the digital map material, vehicle data which can indicate that the facility for stationary traffic is located under roof or inside a building, an determination unit which is designed to determine based on the captured vehicle data whether the facility for stationary traffic is located under a roof or inside a building, an updating unit which is designed to update the digital map material in that information about whether the facility for stationary traffic is located under roof or inside a building is stored if it is determined that the facility for stationary traffic is located under roof or in a building, and a provision unit which is designed to provide the updated digital map material.

A system is therefore specified using which improved navigation to a facility for stationary traffic represented in digital map material is enabled. Based on the updated digital map material, it is possible to navigate reliably to the facility for stationary traffic in this case, even if it is located under roof or inside a building and accordingly receiving GPS signals is only possible through a restricted extent or the facility for stationary traffic or an entry thereto can only be recognized with difficulty.

In at least one embodiment, the capture unit is designed to capture the vehicle data after the vehicle has reached a position of the facility for stationary traffic stored in the digital map material. It can be ensured in this way that the vehicle data are only captured when this is also necessary, by which resources, in particular storage capacities, can be saved, so that the method can also be executed on computing units having comparatively few resources.

The vehicle data can in this case be a current signal reliability of the GPS signal and/or data captured by light sensor and/or data captured by a rain sensor and/or data captured by an ambient temperature sensor and/or data captured by a sensor which is designed to detect a height change. Overall, the vehicle data can include all data, in particular data about a signal quality and/or whether data and/or light data, based on which it can be determined whether the vehicle is located under roof and/or in a building.

In this case, the fact that the vehicle data include a current signal reliability of a GPS signal and/or data captured by light sensor and/or data captured by rain sensor and/or data captured by an ambient temperature sensor and/or data captured by sensor which is designed to detect a height change is only one possible embodiment, however. Rather, the vehicle data can also include other data, for example, which indicate that the vehicle is driving onto another level or into another floor.

The vehicle can furthermore be a motor vehicle. In particular in motor vehicles, it can prove to be disadvantageous here that it is often only possible to receive GPS signals in enclosed buildings to a restricted extent, or facilities for stationary traffic represented in digital map material or the entries thereto can often only be recognized with difficulty if the facility for stationary traffic is located under roof or in a building, which additionally obstructs navigation to the facility for stationary traffic.

The facility for stationary traffic and furthermore be a charging station for electric vehicles. The number of charging stations for electric vehicles is thus increasing continuously and charging stations are also arranged more and more under roofs or in buildings, for example, parking garages or underground garages.

At least one embodiment also specifies a system for navigating a vehicle to a facility for stationary traffic by means of digital map material, wherein the system includes a navigation system which is designed to navigate to a destination based on digital map material, an input unit which is designed to receive an input that defines a destination of a route plan by the navigation system, and an above-described system for updating digital map material for a navigation system, wherein the system for updating digital map material for a navigation system is designed to update the digital map material of the navigation system, wherein the receiving unit is designed to receive an input which defines a facility for stationary traffic as the destination of a route plan by the navigation system, and wherein the navigation system is designed to navigate to the facility for stationary traffic based on the updated digital map material.

A system is therefore specified using which improved navigation to a facility for stationary traffic represented in digital map material is again enabled. Based on the updated digital map material, it is possible to navigate reliably here to the facility for stationary traffic, even if it is located under a roof or inside a building and accordingly receiving GPS signals is only possible to a restricted extent or the facility for stationary traffic or an entry thereto can only be recognized with difficulty.

In summary, it can be stated that a method for updating digital map material of a navigation system is specified by the present invention, using which the digital map material can be expanded or supplemented with information which indicates whether a facility for stationary traffic contained or represented in the digital map material is located under a roof or in a building.

The invention will be explained in more detail on the basis of the appended drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a flow chart of a method for updating digital map material for a navigation system according to embodiments of the invention;

FIG. 2 shows a schematic block diagram of a system for updating digital map material for a navigation system according to embodiments of the invention.

### DETAILED DESCRIPTION OF THE DRAWINGS

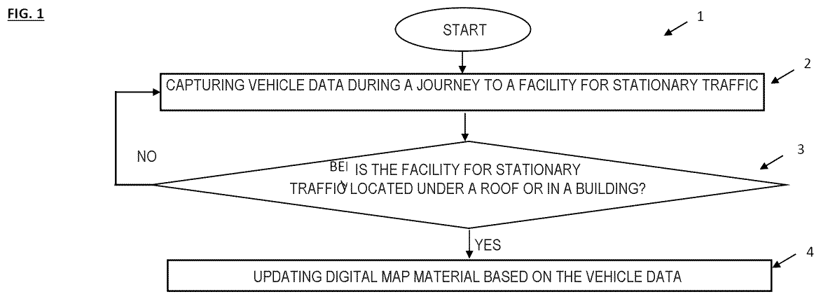

FIG. 1 shows a flow chart of a method for updating digital map material for a navigation system 1 according to embodiments of the invention.

Conventional navigation systems are based here on a current location being calculated from signals of a global positioning system (GPS) and a destination guidance taking place based on the current location and digital map material.

However, it has proven to be disadvantageous in this case that is often only possible to receive GPS signals in enclosed buildings to a restricted extent. Moreover, facilities for stationary traffic represented in the digital map material or the entries thereto can often only be recognized with difficulty, in particular if the object is located under a roof or in a building, which additionally obstructs navigation to the object.

FIG. 1 shows for this purpose a method 1, wherein in step 2, during navigation of a vehicle to a facility for stationary traffic represented in the digital map material by the navigation system, vehicle data which can indicate that the object is located under a roof or inside a building are captured, wherein in a step 3, it is determined based on the captured vehicle data whether the facility for stationary traffic is located under a roof or inside a building, and wherein in a step 4, if it is determined that the facility for stationary traffic is located under roof or inside a building, the digital map material is updated in that information about the facility for stationary traffic being located under roof or in a building is stored in the digital map material, and the correspondingly updated map material is provided.

In contrast, if it is determined that the facility for stationary traffic is not located under a roof or in a building, steps 2 and 3 are repeatedly executed.

Based on the updated digital map material, it is then possible to navigate reliably to the facility for stationary traffic, even if it is located under a roof or inside a building and accordingly receiving GPS signals is only possible to a restricted extent, or the facility for stationary traffic or an entry thereto can only be recognized with difficulty.

Overall, a method 1 is therefore specified using which improved navigation to a facility for stationary traffic represented in digital map material is enabled.

According to the embodiments of FIG. 1, the vehicle data in step 2 are captured after the vehicle has reached a position of the facility for stationary traffic stored in the digital map material.

Moreover, it is also possible to capture the vehicle data only if route planning to the facility for stationary traffic by the navigation system has been activated.

Furthermore, in some embodiments the digital map material can also be updated only if the results of the determination of whether the facility for stationary traffic is located under a roof or in a building has a high confidence value and/or a series of vehicles, for example, 10 vehicles, have supplied the same determination result.

According to the embodiments of FIG. 1, the vehicle data include in this case a current signal reliability of a GPS signal, data captured by a light sensor and data captured by a rain sensor, data captured by an ambient temperature sensor, and data captured by a sensor which is designed to detect a height change.

The vehicle is furthermore a motor vehicle.

The facility for stationary traffic is moreover a charging station for electric vehicles.

Furthermore, the facility for stationary traffic can be arranged, for example, in a parking garage or in an underground garage.

For example, if an electric vehicle is driving to a charging station which is located on a building, for example, an underground garage, it can be determined here based on a current signal reliability of a GPS signal, data captured by a light sensor, and data captured by a rain sensor that the charging station is located in a building and the digital map material are updated accordingly. For example, a suddenly significantly reduced signal reliability, or a sudden change in the light conditions and/or of data captured by the rain sensor, or sudden significant changes of the ambient temperature, or a detected height change can indicate that the motor vehicle is currently located and therefore the charging station is also located in a building.

The updated digital map data can subsequently be used to navigate to the facility for stationary traffic. In this case, it is furthermore possible to search, for example, deliberately for a sheltered charging station.

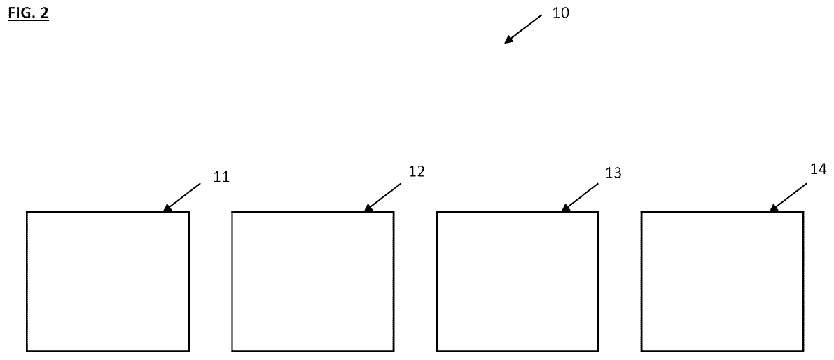

FIG. 2 shows a schematic block diagram of a system for updating digital map material for a navigation system 10 according to embodiments of the invention.

As FIG. 2 shows, the system 10 includes a capture unit 11, which is designed, during a journey of a vehicle to a facility for stationary traffic represented in the digital map material, to capture vehicle data which can indicate that the facility for stationary traffic is located under a roof or inside a building, a determination unit 12 which is designed to determine based on the captured vehicle data whether the facility for stationary traffic is located under a roof or inside a building, an updating unit 13 which is designed to update the digital map material in that information about the fact that the facility for stationary traffic is located under a roof or inside a building is stored if it is determined that the facility for stationary traffic is located under a roof or in a building, and a provision unit 14 which is designed to provide the updated digital map data.

The capture unit can include, for example, corresponding sensors and/or control units in this case.

The determination unit and the updating unit can furthermore each be implemented, for example, based on code stored in a memory and executable by a processor.

The provision unit can furthermore be a transmitter which is designed to transmit corresponding data.

According to the embodiments of FIG. 2, the capture unit 11 is designed to capture the vehicle data after the vehicle has reached a position of the facility for stationary traffic stored in the digital map material.

The vehicle data again include a current signal reliability of a GPS signal, data captured by light sensor, data captured by a rain sensor, data captured by an ambient temperature sensor, and data captured by a sensor which is designed to detect a height change.

The vehicle is furthermore again a motor vehicle.

The facility for stationary traffic is moreover again a charging station for electric vehicles.

The illustrated system 10 is moreover designed to carry out an above-described method for updating digital map material for a navigation system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 method
2 method step
3 method step
4 method step
10 system
11 capture unit
12 determination unit
13 updating unit
14 provision unit

What is claimed is:

1. A method for updating digital map material for a navigation system, comprising:
during a journey of a vehicle to a facility for stationary traffic represented in the digital map material, capturing vehicle data that can indicate that the facility for stationary traffic is located under a roof or inside a building;
determining whether the facility for stationary traffic is located under a roof or inside a building based on the captured vehicle data; and
in response to determining that the facility for stationary traffic is located under a roof or inside a building, updating the digital map material in that information about whether the facility for stationary traffic is located under a roof or inside a building is stored, and
providing the updated digital map material.

2. The method of claim 1, wherein the vehicle data is captured after the vehicle has reached a position of the facility for stationary traffic stored in the digital map material.

3. The method of claim 1, wherein the vehicle data includes at least one of: a current signal reliability of a GPS signal, data captured by light sensor, data captured by rain sensor, data captured by an ambient temperature sensor, and data captured by a sensor configured to detect a height change.

4. The method of claim 1, wherein the vehicle is a motor vehicle.

5. The method of claim 1, wherein the facility for stationary traffic is a charging station for charging electric vehicles.

6. A method for navigating a vehicle to a facility for stationary traffic by means of digital map material, comprising:
updating the digital map material via the method of claim 1;
receiving an input which defines a facility for stationary traffic as the destination of a route plan by the navigation system; and
navigating to the facility for stationary traffic based on the updated digital map material.

7. A system for updating digital map material for a navigation system, comprising:
a capture unit configured to, during a journey of a vehicle to a facility for stationary traffic represented in the digital map material, capture vehicle data that can indicate that the facility for stationary traffic is located under a roof or inside a building;
a determination unit configured to determine, based on the captured vehicle data, whether the facility for stationary traffic is located under a roof or inside a building;
an updating unit configured to update the digital map material such that information about the facility for stationary traffic being located under roof or inside a building is stored when it is determined that the facility for stationary traffic is located under a roof or in the building; and
a provision unit configured to provide the updated digital map material.

8. The system of claim 7, wherein the capture unit is configured to capture the vehicle data after the vehicle has reached a position of the facility for stationary traffic stored in the digital map material.

9. The system of claim 7, wherein the vehicle data includes at least one of: a current signal reliability of a GPS signal, data captured by light sensor, data captured by rain sensor, data captured by an ambient temperature sensor, and data captured by a sensor configured to capture a height change.

10. The system of claim 7, wherein the vehicle is a motor vehicle.

11. The system of claim 7, wherein the facility for stationary traffic is a charging station for charging electric vehicles.

12. A system for navigating a vehicle to a facility for stationary traffic by means of digital map material, comprising:
a navigation system configured to navigate to a destination based on digital map material;
an input unit configured to receive an input that defines a destination of a route plan by the navigation system; and
a system for updating digital map material of claim 7,
wherein the system for updating digital map material is designed to update the digital map material of the navigation system,
wherein the receiving unit is designed to receive an input that defines a facility for stationary traffic as the destination of a route plan by the navigation system, and
wherein the navigation system is designed to navigate to the facility for stationary traffic based on the updated digital map data.
